(19) United States
(12) Patent Application Publication
(10) Pub. No.: US 2026/0213465 A1
(43) Pub. Date: Jul. 23, 2026

(54) SHIELDED CONNECTOR

(71) Applicant: Yazaki Corporation, Tokyo (JP)

(72) Inventors: Sota KAWARASAKI, Shizuoka (JP); Kei OHASHI, Shizuoka (JP)

(73) Assignee: Yazaki Corporation, Tokyo (JP)

(21) Appl. No.: 19/441,320

(22) Filed: Jan. 6, 2026

(30) Foreign Application Priority Data
Jan. 22, 2025 (JP) 2025-009146

(51) Int. Cl. H01R 13/6581; H01R 13/6592

(52) U.S. Cl. CPC H01R 13/6581; H01R 13/6592

(57) ABSTRACT

A shielded connector includes: a housing having a fitting portion fitted to a counterpart connector; a first shield shell externally fitted to the housing to cover a back face on a side opposite to the fitting portion; a second shield shell covering a portion of a front face of the housing excluding the fitting portion; a bolt configured to fasten and fix the first shield shell to the second shield shell; and a fixing bolt configured to fasten and fix, to a fixed portion, a two-layered portion in which a fixing piece of the first shield shell and a fixing piece of the second shield shell are superposed.

### CROSS-REFERENCE TO RELATED APPLICATION(S)

This application is based upon and claims the benefit of priority from prior Japanese patent application No. 2025-009146 filed on January 22, 2025, the entire contents of which are incorporated herein by reference.

### BACKGROUND

### 1. Field of the Invention

The present disclosure relates to a shielded connector.

### 2. Description of the Related Art

In the related art, as disclosed in, for example, JP2017-4806A and JP2023-170052A, a shielded connector attached to a case of a device includes a housing made of a synthetic resin and formed in a substantially L shape. The housing includes a fitting portion that accommodates a terminal connected to an end of an electric wire and is fitted to a device-side connector (counterpart connector), and an electric wire introduction portion into which the electric wire connected to the terminal is introduced from a direction intersecting a fitting direction of the fitting portion. A metal shield shell having conductivity covers the outside of the housing.

In the shield shell, a first shield shell that covers the housing from behind and a second shield shell that covers the electric wire introduction portion of the housing from a counterpart terminal side are integrally formed by being fastened with bolts. The shielded connector is electrically connected and fixed to the case of the device by fixing a fixed portion of the first shield shell to the case of the device with fastening bolts.

However, a shield shell in the related art is integrally formed by fastening the first shield shell and the second shield shell with bolts. Therefore, if a sufficient fastening force is not secured due to a manufacturing tolerance of the first shield shell and the second shield shell, the shortage of an axial force of the bolt, or the like, a contact force between the first shield shell and the second shield shell is weakened, and there is a possibility that the shielding performance of the shield shell is deteriorated.

### SUMMARY

The present disclosure has been made in view of the above circumstances, and an object thereof is to provide a shielded connector capable of stably maintaining the shielding performance of a shield shell.

According to an aspect of the present disclosure, there is provided a shielded connector including: a housing having a fitting portion fitted to a counterpart connector; a first shield shell externally fitted to the housing to cover a back face on a side opposite to the fitting portion; a second shield shell covering a portion of a front face of the housing excluding the fitting portion; a bolt configured to fasten and fix the first shield shell to the second shield shell; and a fixing bolt configured to fasten and fix, to a fixed portion, a two-layered portion in which a fixing piece of the first shield shell and a fixing piece of the second shield shell are superposed.

According to the present disclosure, it is possible to provide a shielded connector capable of stably maintaining the shielding performance of a shield shell.

The present disclosure has been briefly described above. Details of the present disclosure can be clarified by reading modes (hereinafter, referred to as "embodiments") for carrying out the invention to be described below with reference to the attached drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view illustrating a state in which a shielded connector according to an embodiment of the present disclosure is fixed to a fixed portion;

FIG. 2 is an exploded perspective view of the shielded connector in FIG. 1;

FIG. 3 is a perspective view illustrating an assembling procedure of the shielded connector illustrated in FIG. 2;

FIG. 4 is a perspective view illustrating a procedure for fixing the shielded connector to the fixed portion;

FIG. 5 is a rear view of the shielded connector fixed to the fixed portion;

FIG. 6 is a cross-sectional view taken along a line X-X of FIG. 4, illustrating a state immediately before the shielded connector is fixed to the fixed portion;

FIG. 7 is a cross-sectional view taken along a line X-X of FIG. 5, illustrating a state in which the shielded connector is fixed to the fixed portion;

FIG. 8 is a cross-sectional view taken along a line Y-Y of FIG. 5, illustrating a state in which the shielded connector is fixed to the fixed portion; and

FIG. 9 is a main part sectional view illustrating a state immediately before a shielded connector according to a reference example is fixed to a fixed portion.

### DETAILED DESCRIPTION OF THE INVENTION

Hereinafter, an embodiment according to the present disclosure will be described with reference to the drawings.

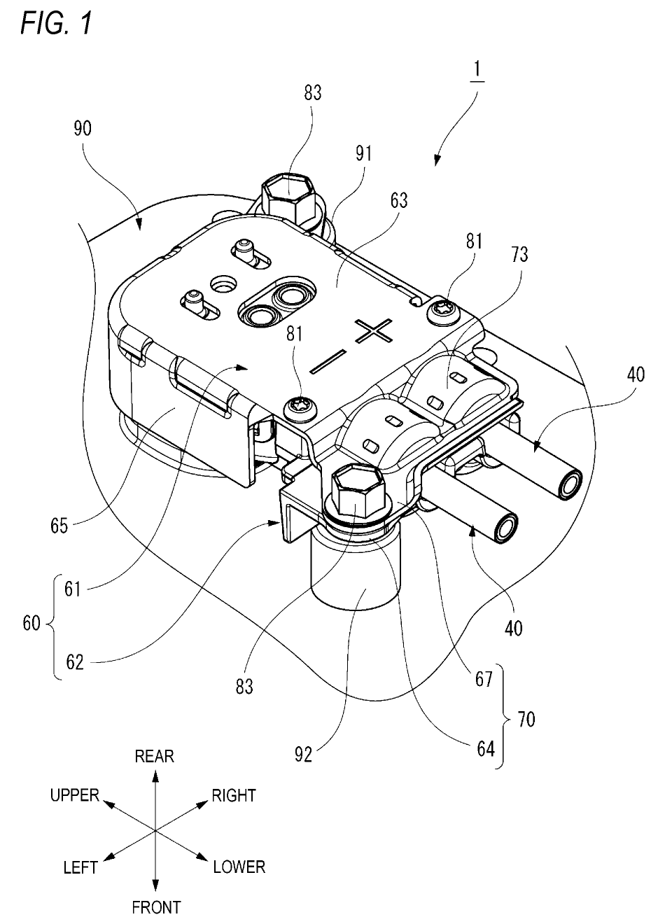

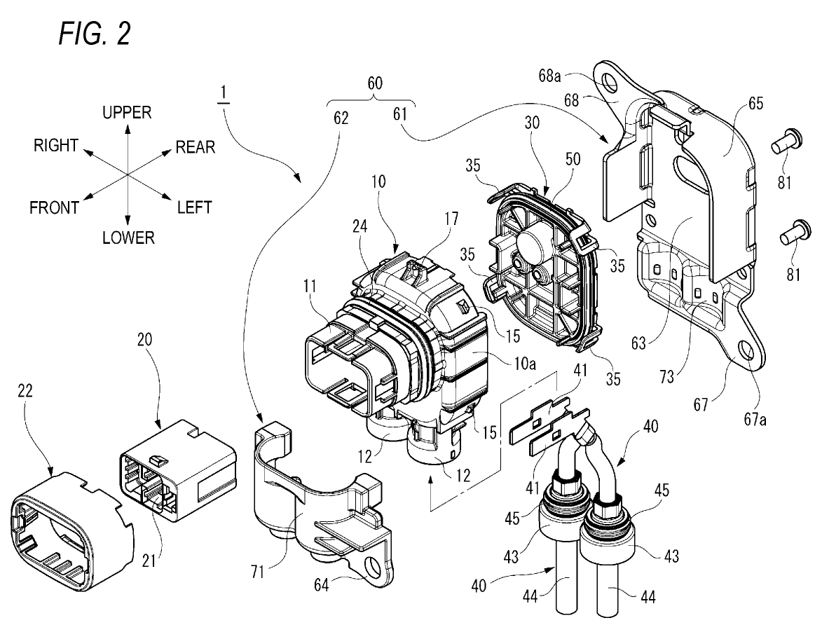

FIGS. 1 and 2 are a perspective view and an exploded perspective view of a shielded connector 1 according to an embodiment of the present disclosure.

In the present specification, a front-rear direction, an up-down direction, and a left-right direction of the shielded connector 1 follow directions of arrows in FIGS. 1 to 3. That is, the front-rear direction is a direction along a connector fitting direction of the shielded connector 1, and a side of a shield case 90 to be fitted into the fitted portion 95 is a front side of a housing 10. The up-down direction is an extension direction of a shielded electric wire 44 orthogonal to the connector fitting direction of the shielded connector 1, and a derivation direction of the shielded electric wire 44 is a downward direction. Further, the left-right direction is a longitudinal direction of a rectangular opening in a fitting portion 11 orthogonal to the connector fitting direction.

As illustrated in FIGS. 1 and 2, the shielded connector 1 according to the present embodiment includes the housing 10, two terminal-equipped electric wires 40, a cover 30, and a shield shell 60. The shielded connector 1 is, for example, a connector used in a power supply circuit such as an inverter or a motor of a vehicle such as a hybrid vehicle or an electric vehicle. The shielded connector 1 is fitted and electrically connected to the fitted portion (counterpart connector) 95 provided in a shield case (fixed portion) 90 such as an inverter or a motor.

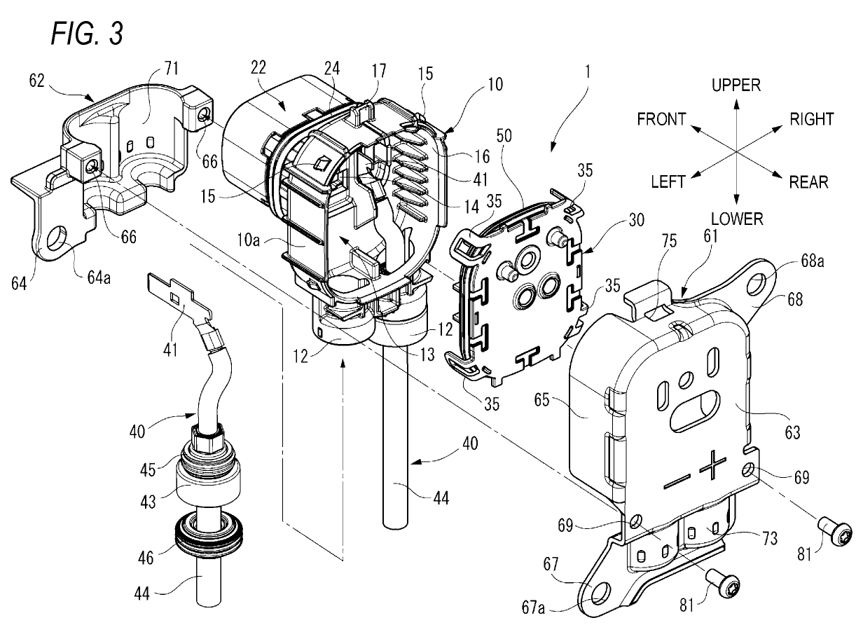

As illustrated in FIGS. 2 and 3, the housing 10 is a housing formed in a substantially L shape, and includes a fitting portion 11 that accommodates tab terminals (terminals) 41 of the terminal-equipped electric wires 40 and is fitted to the fitted portion 95, and electric wire introduction portions 12 that are introduced from a direction in which terminals of the shielded electric wires 44 connected to the tab terminals 41 intersect with a fitting direction (front-rear direction in FIG. 2) of the fitting portion 11.

The fitting portion 11 is formed in a bottomed cylindrical shape having a rectangular opening, and protrudes forward in the fitting direction of the housing 10 with the fitted portion 95. A pair of terminal through holes 14 (see FIG. 3) is formed in a bottom portion of the fitting portion 11.

A packing 24 and a front holder 22 are assembled to an outer periphery of the fitting portion 11, and an inner housing 20 including a terminal accommodating chamber 21 is assembled to an inner periphery of the fitting portion 11.

Each electric wire introduction portion 12 extends in a downward direction that intersects with the fitting direction of the housing 10 with the fitted portion 95. Electric wire through holes through which the shielded electric wires 44 are inserted are formed in the electric wire introduction portions 12.

A rear portion of the housing 10 opposite to the fitting portion 11 is an accommodating portion 13 formed in a concave shape open to an opening 16. The cover 30 is assembled to the opening 16 opposite to the fitting portion 11 in the rear portion of the housing 10. The housing 10 and the cover 30 are formed of a synthetic resin having electrical insulation properties.

When the cover 30 is assembled to the housing 10, the opening 16, which is an attaching working hole of the terminal-equipped electric wire 40, is covered with the cover 30. In addition, a plurality of locking claws 15 project from the outer peripheral surface 10a of the housing 10. In addition, a locking projection 17 is provided to protrude at an upper center of the outer peripheral surface 10a.

As illustrated in FIGS. 2 and 3, the cover 30 is formed in a substantially rectangular plate shape and is assembled to the opening 16 of the housing 10 from a rear side via the annular seal member 50.

The seal member 50 is attached to the outer peripheral side seal surface of the cover 30, and waterproofs and seals a gap between the opening 16 of the housing 10 and the cover 30.

Accordingly, the opening 16 of the accommodating portion 13 of the housing 10 is sealed by the cover 30 in a watertight manner. A plurality of locking pieces 35 having locking holes are formed in a peripheral edge of the cover 30. The locking claws 15 formed in the housing 10 enter the locking holes of the locking pieces 35 by assembling the cover 30 to the housing 10. The locking pieces 35 are locked by the locking claws 15, and the cover 30 is held in an assembled state with respect to the housing 10.

As illustrated in FIG. 2, each terminal-equipped electric wire 40 includes the shielded electric wire 44, the tab terminal (terminal) 41 connected to a conductor terminal of the shielded electric wire 44, a shield terminal 43 connected to a braid (shield member) of the shielded electric wire 44, and seal packings 45 and 46 for sealing a gap between the electric wire introduction portion 12 of the housing 10 and the shielded electric wire 44.

The shielded electric wire (electric wire) 44 is configured as a coaxial cable including a core wire disposed from a center thereof, an inner coating covering the core wire, a conductive braid covering the inner coating, and an outer sheath covering the braid.

The tab terminal 41 is formed of, for example, a conductive metal material such as copper, a copper alloy, aluminum, or an aluminum alloy. The tab terminal 41 is crimped to the core wire exposed at a terminal of the shielded electric wire 44 and is electrically connected to the shielded electric wire 44.

The tab terminal 41 is inserted into and electrically connected to an electrical connection portion of a counterpart terminal (not illustrated) provided in the fitted portion 95.

In the terminal-equipped electric wire 40 assembled to the housing 10, the shielded electric wires 44 are inserted into the electric wire through holes of the electric wire introduction portions 12, and the tab terminals 41 are inserted into terminal through holes 14 of the fitting portion 11 and are accommodated in the terminal accommodating chamber 21 of the inner housing 20. Thus, the tab terminals 41 of the terminal-equipped electric wires 40 are fixed to the fitting portion 11 of the housing 10.

The seal packings 45 and 46 are attached to the shielded electric wires 44 of the terminal-equipped electric wire 40. The seal packing 45 seals a gap between the shield terminal 43 connected to the braid of the shielded electric wire 44 and the electric wire introduction portion 12. The seal packing 46 seals a gap between the shielded electric wire 44 and the shield terminal 43. The seal packings 45 and 46 seal a gap between the shielded electric wire 44 and the electric wire introduction portion 12.

As illustrated in FIGS. 2 and 3, the shielded connector 1 according to the present embodiment includes the shield shell 60 including an upper shield shell (first shield shell) 61 assembled from a rear side of the housing 10 and a lower shield shell (second shield shell) 62 assembled from a lower side. The upper shield shell 61 is formed by pressing a metal plate, and the lower shield shell 62 is formed by die casting of molten metal.

The upper shield shell 61 is formed in a box shape having a substantially rectangular flat bottom plate portion 63 and a peripheral wall 65 erected on a peripheral edge of the bottom plate portion 63. The bottom plate portion 63 covers a rear face of the housing 10, and the peripheral wall 65 covers an upper face and left and right side faces (side faces) of the housing 10. A first electric wire clamping portion 73 for clamping the shield terminal 43 of the terminal-equipped electric wire 40 extending from the electric wire introduction portion 12 of the housing 10 is provided below the bottom plate portion 63.

The upper shield shell 61 is provided with a fixing piece 67 protruding from a left side portion of the first electric wire clamping portion 73 and having a hole portion 67a, an attachment piece 68 protruding from an upper right corner portion of the peripheral wall 65 and having a hole portion 68a, a pair of through holes 69 formed below the bottom plate portion 63, and a locking hole 75 formed at an upper center of the peripheral wall 65.

The lower shield shell 62 includes a second electric wire clamping portion 71 for clamping the shield terminal 43 of the terminal-equipped electric wire 40 extended from the electric wire introduction portion 12 of the housing 10, and covers a portion of the front face of the housing 10 excluding the fitting portion 11. Further, the lower shield shell 62 is provided with a fixing piece 64 protruding from a left side portion of the second electric wire clamping portion 71 corresponding to the fixing piece 67 and having a hole portion 64a, and a pair of screw holes 66 formed above the second electric wire clamping portion 71 corresponding to the pair of through holes 69.

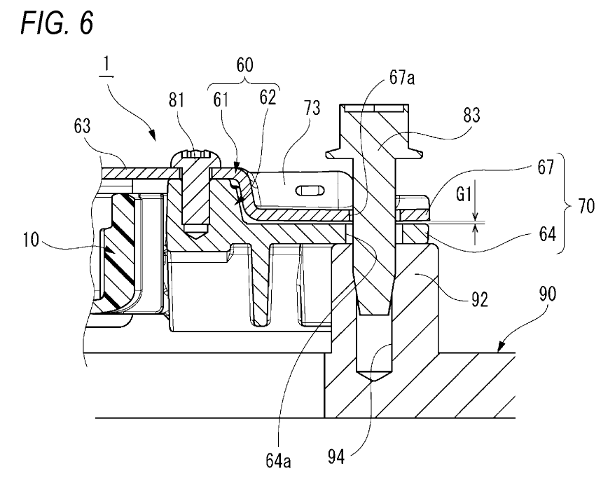

An outer dimension of the upper shield shell 61 is set such that, when the lower shield shell 62 is fastened and fixed by bolts 81, a clearance G1 (see FIG. 6) is generated between opposing faces of a two-layered portion 70 in which the fixing piece 67 of the first electric wire clamping portion 73 and the fixing piece 64 of the second electric wire clamping portion 71 are superposed. That is, for example, when the upper shield shell 61 is press-formed, a lower end of the first electric wire clamping portion 73 is integrally formed in a shape slightly inclined to a side away from the second electric wire clamping portion 71.

Next, a case of assembling the shielded connector 1 according to the present embodiment will be described.

First, as illustrated in FIG. 3, after the shielded electric wires 44 of the terminal-equipped electric wires 40 are passed through the electric wire introduction portions 12 of the housing 10 and the tab terminals 41 are pulled out toward the accommodating portion 13, the tab terminals 41 are inserted into the terminal through holes 14 of the housing 10.

The cover 30 is brought close to the accommodating portion 13 of the housing 10 to cover the opening 16 from a rear side, and the locking claws 15 of the housing 10 are locked to the locking pieces 35 of the cover 30. Thus, the seal member 50 attached to the housing 10 can waterproof and seal a gap between the opening 16 of the housing 10 and the cover 30.

Next, the shield shell 60 is attached to the housing 10.

First, the upper shield shell 61 of the shield shell 60 is attached from the rear side to cover the housing 10 to which the cover 30 is assembled.

At this time, the upper shield shell 61 is attached behind the housing 10 so that the first electric wire clamping portion 73 covers the electric wire introduction portion 12 after the locking hole 75 is locked to the locking projection 17 of the housing 10.

Next, the lower shield shell 62 of the shield shell 60 is attached from the lower side to cover the electric wire introduction portion 12 of the housing 10.

The upper shield shell 61 and the lower shield shell 62 are attached to the housing 10, and the through holes 69 of the upper shield shell 61 and the screw holes 66 of the lower shield shell 62 communicate with each other. Thereafter, the upper shield shell 61 and the lower shield shell 62 are fixed to the housing 10 by inserting the bolts 81 into the through holes 69 and screwing the bolts 81 into the screw holes 66.

Here, the upper shield shell 61 and the lower shield shell 62 fixed to the housing 10 are configured such that the clearance G1 is generated between the opposing faces of the two-layered portion 70 in which the fixing piece 67 of the first electric wire clamping portion 73 and the fixing piece 64 of the second electric wire clamping portion 71 are superposed (see FIG. 6). Therefore, in a case where there is a variation in manufacturing tolerance between the upper shield shell 61 and the lower shield shell 62, the two-layered portion 70 does not come into contact with each other first when the bolts 81 are fastened, and the bolts 81 can be completely seated.

Therefore, in the shielded connector 1 according to the present embodiment, a sufficient fastening force can be secured by an axial force of the bolts 81, a contact force between the upper shield shell 61 and the lower shield shell 62 does not become weak, and the shielding performance of the shield shell 60 can be prevented from deteriorating.

The upper shield shell 61 and the lower shield shell 62 are electrically connected to each other with the bolts 81. Further, one end of the braid of the shielded electric wires 44 is electrically connected to the shield shell 60 by the shield terminal 43 of the terminal-equipped electric wire 40.

Next, a procedure for fixing the shielded connector 1 according to the present embodiment to the shield case 90 will be described.

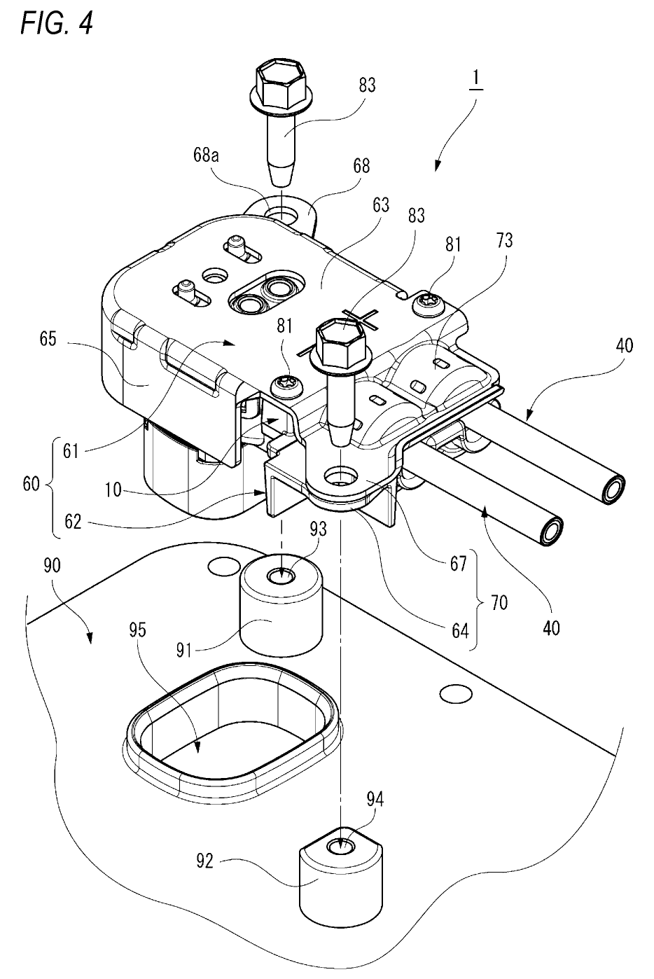

First, as illustrated in FIG. 4, in the shielded connector 1 having the above structure, the fitting portion 11 side is fitted to the fitted portion 95 provided in the shield case 90. Accordingly, the tab terminal 41 in the fitting portion 11 is inserted into and electrically connected to the electrical connection portion of the counterpart terminal. When the shielded connector 1 is fitted to the fitted portion 95, the packing 24 comes into close contact with an inner peripheral surface of the fitted portion 95. Thus, a fitting part between the shielded connector 1 and the fitted portion 95 is sealed.

When the shielded connector 1 is fitted to the fitted portion 95, the attachment piece 68 of the upper shield shell 61 is placed on a fixing boss 91 of the shield case 90, and the two-layered portion 70 of the shield shell 60 is placed on a fixing boss 92 of the shield case 90. Thus, the hole portion 68a of the attachment piece 68 and the screw hole 93 of the fixing boss 91 communicate with each other, and the hole portions 64a and 67a of the fixing pieces 64 and 67 and the screw hole 94 of the fixing boss 92 communicate with each other.

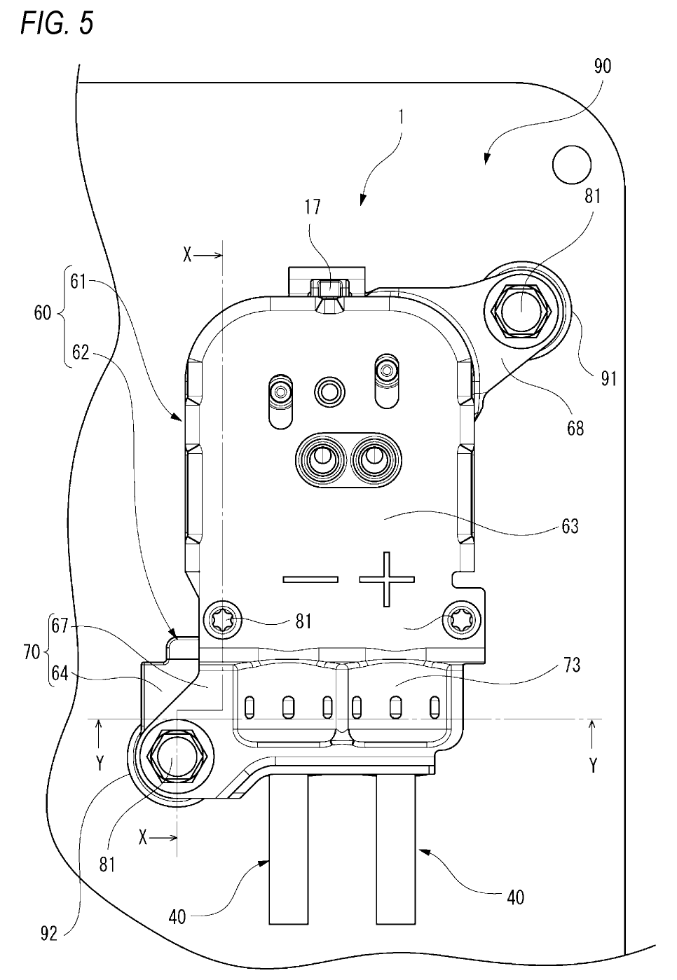

Therefore, as illustrated in FIG. 5, a fixing bolt 83 inserted into the hole portion 68a of the attachment piece 68 of the upper shield shell 61 is screwed into the screw hole 93 of the fixing boss 91, and a fixing bolt 83 inserted into the hole portions 64a and 67a of the fixing piece 64 and 67 is screwed into the screw hole 94 of the fixing boss 92. Thus, the shielded connector 1 is pushed toward the fitted portion 95 by a fastening force of the fixing bolt 83. Accordingly, the shielded connector 1 can be easily fitted to the fitted portion 95.

In the shielded connector 1 according to the present embodiment, the clearance G1 is provided between the opposing faces of the two-layered portion 70, and the fixing bolt 83 is fastened and fixed against a repulsive force in a direction in which the fixing piece 67 of the upper shield shell 61 and the fixing piece 64 of the lower shield shell 62 are separated from each other.

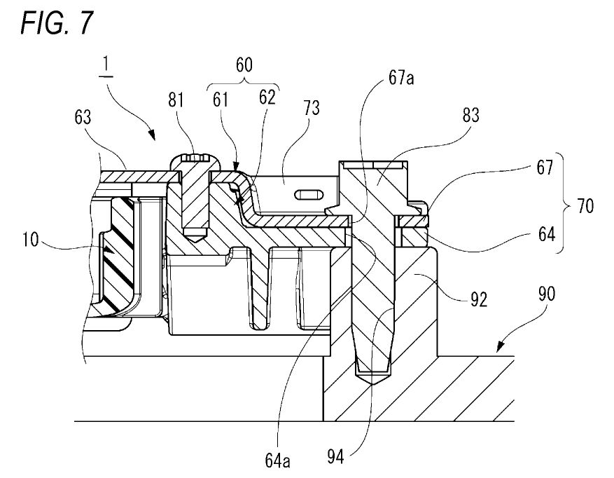

That is, as illustrated in FIG. 6, in a state immediately before the shielded connector 1 is fixed to the fitted portion 95, there is the clearance G1 defined by the first electric wire clamping portion 73 having a cantilever shape for fastening and fixing the bolts 81 between the opposing faces of the two-layered portion 70. When the fixing bolt 83 is fastened, as illustrated in FIG. 7, the fixing piece 67 of the upper shield shell 61 is elastically deformed in a direction of crushing the clearance G1 to generate a repulsive force, but the fixing bolt 83 larger than the bolt 81 can generate a sufficient axial force.

Therefore, the contact force between the upper shield shell 61 and the lower shield shell 62 does not become weak due to the shortage of an axial force of the bolt 81, and a necessary minimum bolt can be adopted as the bolt 81 for fastening and fixing the upper shield shell 61 and the lower shield shell 62, and a size of the product can be reduced.

By fastening the fixing piece 67 of the upper shield shell 61 and the fixing piece 64 of the lower shield shell 62 by the fixing bolts 83 for fixing the shielded connector 1 to the shield case 90, even when the axial force of the bolt 81 is insufficient, the shield shell 60 is electrically reliably connected to the shield case 90. Accordingly, the shielded connector 1 is covered with the shield shell 60 fixed to the shield case 90, and a good electromagnetic shielding effect is obtained.

In the shielded connector 1 according to the present embodiment, the first electric wire clamping portion 73 of the upper shield shell 61 and the second electric wire clamping portion 71 of the lower shield shell 62 are electrically connected to the braid of the terminal-equipped electric wire 40 by clamping the shield terminal 43 of the terminal-equipped electric wire 40 accommodated in the housing 10.

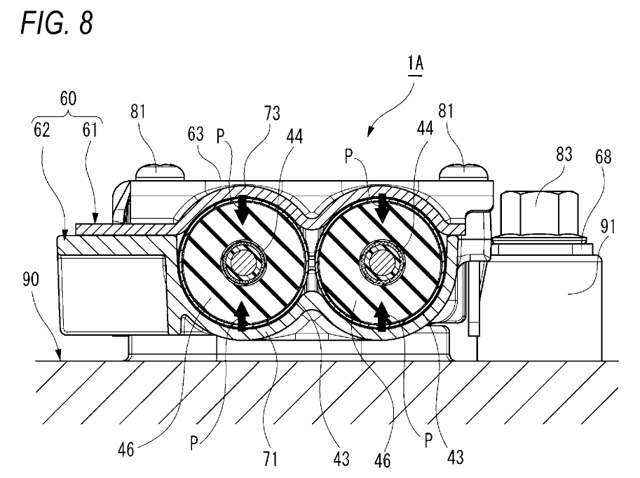

Therefore, by fastening the fixing piece 67 of the upper shield shell 61 and the fixing piece 64 of the lower shield shell 62 by the fixing bolts 83, as illustrated in FIG. 8, a load P by which the first electric wire clamping portion 73 of the upper shield shell 61 and the second electric wire clamping portion 71 of the lower shield shell 62 clamp the shield terminal 43 of the terminal-equipped electric wire 40 increases, and a contact resistance can be reduced.

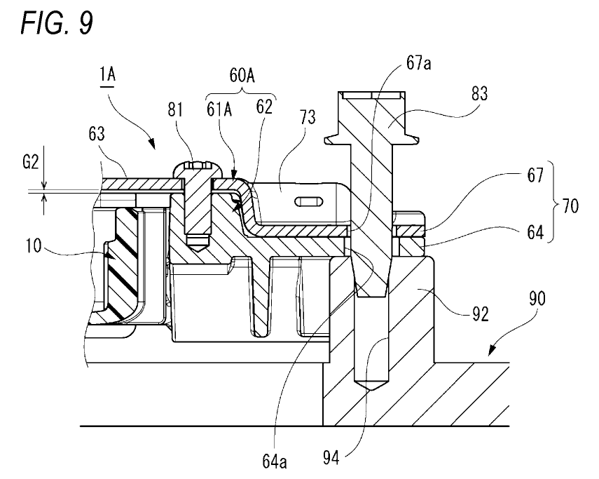

FIG. 9 is a main part sectional view illustrating a state immediately before a shielded connector 1A according to a reference example is fixed to a fixed portion.

The shielded connector 1A according to the reference example is different from that according to the above-described embodiment in a shape of the upper shield shell 61A. In the following, the same components as those in the above embodiment are denoted by the same reference numerals, and the description thereof is omitted.

As illustrated in FIG. 9, an outer dimension of the upper shield shell 61A according to the reference example are set such that, when the lower shield shell 62 is fastened and fixed by the bolts 81, the clearance G1 is not generated between the opposing faces of the two-layered portion 70 in which the fixing piece 67 of the first electric wire clamping portion 73 and the fixing piece 64 of the second electric wire clamping portion 71 are superposed. That is, the upper shield shell 61A is integrally formed in such a shape that the first electric wire clamping portion 73 is in surface contact with the second electric wire clamping portion 71, for example, at the time of press molding.

Therefore, in a case where there is a variation in manufacturing tolerance between the upper shield shell 61A and the lower shield shell 62, the two-layered portion 70 come into contact with each other first when the bolts 81 are fastened, and a clearance G2 may be generated between the bottom plate portion 63 of the upper shield shell 61A and the lower shield shell 62.

Therefore, in the shielded connector 1A according to the reference example, there is a possibility that the bolt 81 cannot be completely seated, a sufficient fastening force cannot be secured by the axial force of the bolt 81, a contact force between the upper shield shell 61A and the lower shield shell 62 becomes weak, and the shielding performance of the shield shell 60A may deteriorate.

On the other hand, in the shielded connector 1 according to the present embodiment described above, the shielding performance of the shield shell 60 can be stably maintained.

In the shielded connector 1 according to the present embodiment, the upper shield shell 61 is formed by pressing a metal plate, and the lower shield shell 62 is formed by die casting. Therefore, a dimension of the clearance G1 defined between the opposing faces of the two-layered portion 70 can be easily controlled only by appropriately setting an outer dimension of the upper shield shell 61 to be press-formed.

In the shielded connector 1 according to the present embodiment, the upper shield shell 61 includes the bottom plate portion 63 that covers the rear face of the housing 10 and the peripheral wall 65 that is suspended from the peripheral edge of the bottom plate portion 63 and covers a side face of the housing 10. Thus, the shielded connector 1 can obtain a good electromagnetic shield effect by a simple assembly operation.

The present disclosure is not limited to the above-described embodiment, and can be appropriately modified, improved, or the like. In addition, materials, shapes, sizes, numbers, arrangement positions, and the like of the components in the embodiment described above are freely selected and are not limited as long as the present disclosure can be implemented.

For example, in the above embodiment, an example in which the lower shield shell 62 is formed by die casting has been described, and the lower shield shell 62 may be formed by press molding.

Here, features of the embodiment of the shielded connector according to the present disclosure described above are briefly summarized and listed in the following [1] to [5]. [1] A shielded connector (1) including:

a housing (10) having a fitting portion (11) fitted to a counterpart connector (fitted portion 95);

a first shield shell (upper shield shell 61) externally fitted to the housing (10) to cover a back face on a side opposite to the fitting portion (11);

a second shield shell (lower shield shell 62) covering a portion of a front face of the housing (10) excluding the fitting portion (11);

a bolt (81) configured to fasten and fix the first shield shell (upper shield shell 61) to the second shield shell (lower shield shell 62); and

a fixing bolt (83) configured to fasten and fix, to a fixed portion (shield case 90), a two-layered portion (70) in which a fixing piece (67) of the first shield shell (upper shield shell 61) and a fixing piece (64) of the second shield shell (lower shield shell 62) are superposed.

According to the shielded connector (1) having the above configuration [1], since the fixing piece (67) of the first shield shell (upper shield shell 61) and the fixing piece (64) of the second shield shell (lower shield shell 62) are fastened by the fixing bolt (83) that fastens and fixes the shielded connector (1) to the fixed portion (shield case 90), the first shield shell (upper shield shell 61) and the second shield shell (lower shield shell 62) are reliably electrically connected to the fixed portion (shield case 90) even when the axial force of the bolt (81) is insufficient. Accordingly, the shielded connector (1) is covered by the first shield shell (upper shield shell 61) and the second shield shell (lower shield shell 62) fixed to the fixed portion (shield case 90), and a good electromagnetic shielding effect is obtained.

[2] The shielded connector (1) according to [1], in which

a clearance (G1) is provided between opposing faces of the two-layered portion (70), and the fixing bolt (83) is fastened and fixed against a repulsive force in a direction in which the fixing piece (67) of the first shield shell (upper shield shell 61) and the fixing piece (64) of the second shield shell (lower shield shell 62) are separated from each other.

According to the shielded connector (1) having the above configuration [2], in a case where there is a variation in manufacturing tolerance between the first shield shell (upper shield shell 61) and the second shield shell (lower shield shell 62), the two-layered portion (70) does not come into contact with each other first when the bolts (81) are fastened, and the bolts (81) can be completely seated. Therefore, in the shielded connector (1) of the present configuration, a sufficient fastening force can be secured by an axial force of the bolt (81), and a contact force between the first shield shell (upper shield shell 61) and the second shield shell (lower shield shell 62) does not become weak, and the shielding performance can be prevented from deteriorating.

[3] The shielded connector (1) according to [2], in which

a first electric wire clamping portion (73) of the first shield shell (upper shield shell 61) and a second electric wire clamping portion (71) of the second shield shell (lower shield shell 62) are electrically connected to a shield member (braid) of the terminal-equipped electric wire (40) by clamping a shield terminal (43) of the terminal-equipped electric wire (40) accommodated in the housing (10).

According to the shielded connector (1) having the above configuration [3], the fixing piece (67) of the first shield shell (upper shield shell 61) and the fixing piece (64) of the second shield shell (lower shield shell 62) are fastened by the fixing bolt (83), so that a load (P) by which the first electric wire clamping portion (73) of the first shield shell (upper shield shell 61) and the second electric wire clamping portion (71) of the second shield shell (lower shield shell 62) clamp the shield terminal (43) of the terminal-equipped electric wire (40) increases, and a contact resistance can be reduced.

[4] The shielded connector (1) according to any one of the above [1] to [3], in which

the first shield shell (upper shield shell 61) is formed by pressing a metal plate, and

the second shield shell (lower shield shell 62) is formed by die casting.

According to the shielded connector (1) having the above configuration [4], a dimension of the clearance (G1) defined between the opposing faces of the two-layered portions (70) can be easily controlled by appropriately setting an outer dimension of the first shield shell (upper shield shell 61) to be press-formed.

[5] The shielded connector (1) according to the above [4], in which

the first shield shell (upper shield shell 61) has a bottom plate portion (63) covering a rear face of the housing (10) and a peripheral wall (65) suspended from a peripheral edge of the bottom plate portion (63) and covering a side face of the housing (10).

According to the shielded connector (1) having a configuration of the above [5], a good electromagnetic shield effect can be obtained by a simple assembly operation.

1. A shielded connector comprising:
a housing having a fitting portion fitted to a counterpart connector;
a first shield shell externally fitted to the housing to cover a back face on a side opposite to the fitting portion;
a second shield shell covering a portion of a front face of the housing excluding the fitting portion;
a bolt configured to fasten and fix the first shield shell to the second shield shell; and
a fixing bolt configured to fasten and fix, to a fixed portion, a two-layered portion in which a fixing piece of the first shield shell and a fixing piece of the second shield shell are superposed.

2. The shielded connector according to claim 1, wherein
a clearance is provided between opposing faces of the two-layered portion, and the fixing bolt is fastened and fixed against a repulsive force in a direction in which the fixing piece of the first shield shell and the fixing piece of the second shield shell are separated from each other.

3. The shielded connector according to claim 2, wherein
a first electric wire clamping portion of the first shield shell and a second electric wire clamping portion of the second shield shell are electrically connected to a shield member of the terminal-equipped electric wire by clamping a shield terminal of the terminal-equipped electric wire accommodated in the housing.

4. The shielded connector according to claim 1, wherein
the first shield shell is formed by pressing a metal plate, and
the second shield shell is formed by die casting.

5. The shielded connector according to claim 4, wherein
the first shield shell includes a bottom plate portion covering a rear face of the housing and a peripheral wall suspended from a peripheral edge of the bottom plate portion and covering a side face of the housing.
